(19) United States
(12) Patent Application Publication
(10) Pub. No.: US 2024/0105082 A1
(43) Pub. Date: Mar. 28, 2024

(54) METHOD FOR PRODUCING SIMULATED ANIMAL ORGAN, SIMULATED ANIMAL ORGAN, SIMULATED ANIMAL ORGAN KIT, AND MEDICAL INSTRUMENT EVALUATION KIT

(71) Applicant: KOTOBUKI MEDICAL INC., Yashio-shi, Saitama (JP)

(72) Inventors: Seiichiro TAKAYAMA, Yashio-shi, Saitama (JP); Gaku MORIMOTO, Yashio-shi, Saitama (JP)

(21) Appl. No.: 18/257,457

(22) PCT Filed: Dec. 16, 2020
(86) PCT No.: PCT/JP2020/046952

§ 371 Date: Jun. 14, 2023

(51) Int. Cl. G09B 23/28

(52) U.S. Cl. CPC G09B 23/28

(57) ABSTRACT

There is provided a method for producing a simulated animal organ. The method includes a shaping step of mixing mannan as a main component, an allochroic agent in the form of a microcapsule that changes its color in a temperature-dependent manner, and water, performing gelatinization, and shaping a gelatinized mixture to obtain a shaped body; and wherein the shaped body is frozen to create a fiber structure or a mesh structure. This method enables the allochroic agent to be supported by the fiber structure or the mesh structure and provides a simulated animal organ that allows a user to evaluate the effect of heating by the extent of color change and is in a state extremely similar to an actual animal organ.

### TECHNICAL FIELD

The present invention relates to a simulated animal organ usable for the purpose of training surgery on an animal including a human, and other purposes.

### BACKGROUND ART

Surgical operations are widely performed on animals including humans. For example, surgery for excision of a tumor or the like from an organ, surgery for partial resection of an organ, surgery for implanting an organ and surgery for suturing an organ are known.

Such surgeries require a surgeon to have a considerable technique in an incising operation with a knife (including an electric knife) and a stitching operation for suture or anastomosis and the like, and therefore, such a technique is usually trained before actually performing surgery.

Therefore, biological models (simulated animal organs) have conventionally been used for practical training in medical education, surgery technique training and the like. Such a simulated animal organ is generally made of a silicone resin or polyurethane, and in addition, a biological model made of a polymer resin has been also proposed (see Japanese Patent No. 4126374). The present applicant has proposed a biological model produced by using mannan as a material for a simulated animal organ (International Publication No. WO 2017/010190).

Furthermore, there has been proposed a technique for identifying a site cauterized with, for example, a high-frequency knife in a conventional biological model made of a polymer resin. In this technique, a microcapsule pigment is contained within a shaped product and heating of the cauterized site is identified based on a color change thereof (Japanese Patent Application Laid-Open No. 2018-49166).

### SUMMARY OF INVENTION

### Technical Problem

However, as disclosed in Japanese Patent Application Laid-Open No. 2018-49166, such a biological model in which a microcapsule pigment is contained in a synthetic resin may produce a toxic substance and an offensive odor when the biological model is cauterized with, for example, a high-frequency knife for surgical technique training. Thus, such a model has a problem in which it is difficult to use in a medical institution (particularly in an operating room). Furthermore, when a synthetic resin is used, the material itself is melted by the high-frequency knife, which leads to another problem in which it is difficult to utilize color change to reproduce, with high accuracy, the thermal diffusion in which heat generated during cauterization propagates to the surrounding area on the biological model.

Besides, in medical facilities, a large number of simulated animal organs having been used for training are discarded. If the simulated animal organs are made of chemical constituent materials such as a silicone resin and a polymer resin, there arises a problem in which the environment is liable to be harmfully affected in disposal of these materials.

The present invention was accomplished in view of the above-described problems, and it is an object of the present invention to provide a simulated animal organ in which influence of heat can be visually identified when practical training in education or surgery training is performed in an environment similar to that of an actual animal organ.

### Solution to Problem

The present invention for achieving the above-described object is a method for producing a simulated animal organ including: a shaping step of mixing mannan as a main component, an allochroic agent in the form of a microcapsule that changes its color in a temperature-dependent manner, and water, performing gelatinization, and shaping a gelatinized mixture to obtain a shaped body; and a freezing step of freezing the shaped body to form a fiber structure or a mesh structure.

In the method for producing a simulated animal organ, the allochroic agent is supported by the fiber structure or the mesh structure in the freezing step.

In the method for producing a simulated animal organ, the particle diameter of the allochroic agent is 5.0 μm or less.

In the method for producing a simulated animal organ, the particle diameter of the allochroic agent is 2.0 μm or less.

In the method for producing a simulated animal organ, the allochroic agent has the property of beginning to turn the color thereof into a first hue when the temperature thereof rises and exceeds a first temperature and beginning to turn the color thereof into a second hue when the temperature thereof in the first hue state drops and falls below a second temperature, which is lower than the first temperature.

The method for producing a simulated animal organ includes: a heating step of heating the shaped body to a temperature higher than the first temperature after the freezing step to turn the allochroic agent into a first hue state; and a cooling step of cooling the shaped body to a temperature lower than the second temperature after the heating step to turn the allochroic agent into a second hue state.

In the method for producing a simulated animal organ, the shaped body is heated to 75° C. or higher in the heating step, the shaped body is cooled to lower than −5° C. in the cooling step, the first temperature for the allochroic agent is set to a temperature higher than 30° C. and lower than 75° C., and the second temperature for the allochroic agent is set to a temperature lower than 20° C. and not lower than −5° C.

In the method for producing a simulated animal organ, the first hue is white or transparent, and the second hue is red, pink, brown, or darkish brown.

In the method for producing a simulated animal organ, the shaped body in the shaping step contains 1.0% by weight or more of the allochroic agent.

In the method for producing a simulated animal organ, the moisture content of the shaped body is 95% or less at the final product stage after the freezing step.

In the method for producing a simulated animal organ, the moisture content of the shaped body is 80% or more at the final product stage after the freezing step.

In the method for producing a simulated animal organ, the compressive elastic modulus of the shaped body is 0.015 N/mm2 or less after the freezing step.

In the method for producing a simulated animal organ, the compressive elastic modulus of the shaped body is 0.011 N/mm2 or less after the freezing step.

The present invention for achieving the above-described object is a method for producing a simulated animal organ including: a shaping step of mixing a raw material containing mannan as a main component, water, and an allochroic agent in the form of a microcapsule that changes a color thereof in a temperature-dependent manner, performing gelatinization, and shaping a gelatinized mixture to obtain a shaped body, wherein the allochroic agent has the property of beginning to turn the color thereof to a first hue when a temperature thereof rises and exceeds a first temperature and beginning to turn the color thereof to a second hue when the temperature thereof in a first hue state drops and falls below a second temperature, which is lower than the first temperature; a heating step of heating the shaped body to a temperature higher than the first temperature to turn the allochroic agent into the first hue state; and a cooling step of cooling the shaped body to a temperature lower than the second temperature after the heating step to turn the allochroic agent into a second hue state.

In the method for producing a simulated animal organ, an electrolyte is mixed with the water in the shaping step.

In the method for producing a simulated animal organ, the shaped body in the shaping step contains the electrolyte in an amount of 1.0% by weight or less.

The present invention for achieving the above-described object is a simulated animal organ produced by any of the above-described production methods.

The present invention for achieving the above-described object is a simulated animal organ kit including: the above-described simulated animal organ formed into a sheet; and a three dimensional organ model formed from a resin or metal, wherein the simulated animal organ is fixed to a part of the wall surface of the organ model.

The present invention for achieving the above-described object is a medical instrument evaluation kit including: a first surface composed of the above-described simulated animal organ; a second surface provided in a direction orthogonal to the first surface, the second surface having the property of changing a color thereof by heat; and a third surface provided in a direction orthogonal to the first surface and spaced from the second surface, the third surface having the property of changing a color thereof by heat.

In the medical instrument evaluation kit, the second surface and the third surface are composed of paper or a resin film.

In the medical instrument evaluation kit, the second surface and the second surface are composed of the simulated animal organ according to claim 13.

The present invention for achieving the above-described object is a simulated animal organ that contains mannan as a main component, an electrolyte, water, and an allochroic agent in the form of a microcapsule, the allochroic agent changing a color thereof in a temperature-dependent manner, and in which the allochroic agent is supported by a fiber structure or mesh structure of the mannan.

In the simulated animal organ, the allochroic agent is supported in a bunch form along the fiber structure or mesh structure of the mannan.

In the simulated animal organ, a recess is formed by the fiber structure or mesh structure of the mannan, and the allochroic agent is housed in the recess.

In the simulated animal organ, the moisture content is 95% or less and 80% or more.

In the simulated animal organ, the compressive elastic modulus is 0.015 N/mm2 or less.

### Advantageous Effects of Invention

The present invention attains an excellent effect that a simulated animal organ can be obtained that allows one to evaluate the effect of heating based on the extent of color change and is in a state extremely similar to an actual animal organ.

### BRIEF DESCRIPTION OF DRAWINGS

FIG. 1 is a flowchart illustrating a production process for a simulated animal organ according to a first embodiment of the present invention.

FIG. 2 is a plan view of the simulated animal organ.

FIG. 3(A) is a plan view of a state where the simulated animal organ is incised with an electric knife, FIG. 3(B) is a plan view of a state where an inside tissue is pinched with forceps in the simulated animal organ, and FIG. 3(C) is a plan view of a state where an incised portion is sutured in the simulated animal organ.

FIG. 4(A) is a cross-sectional view of the simulated animal organ in a multilayer form, and FIGS. 4(B) to 4(D) are cross-sectional views illustrating other constitutional examples of the simulated animal organ.

FIG. 5 FIGS. 5(A) and 5(B) are photographs showing drips from the simulated animal organ according to Example, and FIG. 5(C) is a photograph showing only allochroic agents.

FIG. 6 FIGS. 6(A) and 6(B) are photomicrographs of the simulated animal organ according to Example.

FIG. 7 is a photomicrograph of the simulated animal organ according to Example.

FIG. 8 FIGS. 8(A) and 8(B) are photomicrographs of the simulated animal organ according to Example.

FIG. 9 FIGS. 9(A) and 9(B) are photomicrographs of the simulated animal organ according to Example.

FIG. 10 is a front view showing a simulated animal organ kit according to a second embodiment of the present invention.

FIG. 11 is an exploded view of a medical instrument evaluation kit according to a third embodiment of the present invention.

FIG. 12(A) is a perspective view of the medical instrument evaluation kit; and FIG. 12(B) is a perspective view illustrating an aspect where the medical instrument evaluation kit is used for evaluation.

FIG. 13 is a perspective view of a modification of the medical instrument evaluation kit.

FIG. 14 is a plan view of a modification of the medical instrument evaluation kit.

### DESCRIPTION OF EMBODIMENT

Embodiments of the present invention will now be described with reference to the accompanying drawings.

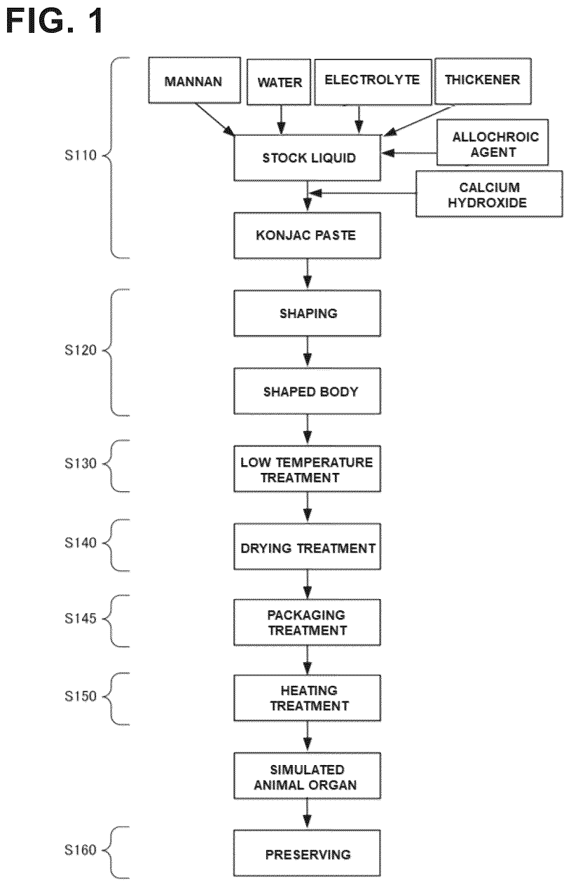

FIG. 1 illustrates a production process for a simulated animal organ according to a first embodiment of the present invention.

<Kneading/Gelatinizing Step (S110)>

In a kneading/gelatinizing step S110, firstly, mannan as a main component, an electrolyte, a thickener, an allochroic agent in the form of a microcapsule that changes its color in a temperature-dependent manner, and water are mixed and kneaded to obtain a stock liquid. Mannan is a polysaccharide containing mannose as a main constitutional unit, and for example, glucomannan, galactomannan, a konjac flour (a kind of glucomannan) or the like can be used. The glucomannan is obtained by polymerizing glucose and mannose in a ratio of about 2:3 to 1:2. The galactomannan is obtained by polymerizing mannose and galactose.

An electrolyte refers to a substance that becomes conductive when dissolved in water, and specifically, the electrolyte becomes a charged ion in water to exhibit a conductive property. Examples of the ion of the electrolyte include a sodium ion, a potassium ion, a calcium ion, a magnesium ion, a chloride ion, a phosphoric acid ion and a hydrogen carbonate ion, but it may be another ionic substance. In this embodiment, sodium chloride (salt) is used as the electrolyte. In other words, a saline solution is used as the aqueous electrolyte solution.

The thickener refers to a substance used for increasing the viscosity of or thickening the stock liquid, and can increase the stability of the konjac paste to prevent separation thereof. The thickener is divided into an animal thickener (such as gelatin) and a plant thickener (such as a polysaccharide or a chemical derivative of cellulose). Specifically, representative examples of the thickener include pectin, guar gam, xanthan gam, tamarind gam, carrageenan, propylene glycol, carboxymethyl cellulose, starch, crystalline cellulose, trehalose and dextrin, and these may be used alone or as a mixture thereof. For example, a mixture of dextrin, starch and a thickening polysaccharide can be used.

The allochroic agent in the form of a microcapsule begins to change its color and gradually turns into a first hue, when the temperature thereof exceeds a first temperature (a temperature at which the color change begins during the temperature rise), which is higher than an ambient temperature under ordinary conditions (normal temperature). Furthermore, when the temperature thereof exceeds a first fixation temperature (a temperature at which the color is fixed during the temperature rise), which is higher than the above-described first temperature, the color is fixed to the first hue. The first temperature is, for example, within the range of 30° C. to 40° C. The first fixation temperature is, for example, set within the range of 30° C. to 80° C., desirably set to 50° C. or higher, and desirably set to lower than 7° C. The first hue may be any color different from a second hue described below; however, the first hue is preferably, for example, white or transparent (colorless).

Furthermore, the allochroic agent begins to change its color and gradually turns into a second hue, when the temperature thereof falls below a second temperature (a temperature at which the color change begins during the temperature drop), which is lower than an ambient temperature under ordinary conditions (normal temperature). Furthermore, when the temperature of the allochroic agent falls below a second preparation completion temperature (a temperature at which preparation is completed during the temperature drop), which is lower than the second temperature, the entire allochroic agent turns into the second hue, completing preparation for color development back into the first hue at the next temperature rise. The second temperature is, for example, within the range of −5 to 20° C., and more preferably within the range of 0° C. to 10° C. The second preparation completion temperature is set, for example, within the range of −5° C. to −20° C. It is preferable that the second hue be any color selected from red, pink, brown, or darkish brown, which is similar to the color of an organ. The color developing agent has a temperature for heat resistance. This temperature for heat resistance is higher than the first fixation temperature and is, for example, 100° C. or higher.

Preferably, an allochroic agent having a particle diameter of 5.0 μm or less is included, and more preferably, one having a particle diameter of 2.0 μm or less is included. Thus, when the allochroic agent is selected, one having a median diameter of 5.0 μm or less is preferable, and one having a median diameter of 2.0 μm or less is more preferable. As the details will be described later, the smaller the particle diameter is, the more easily the allochroic agent is supported by the fiber structure or mesh structure of the mannan and the more easily the allochroic agent aggregates to form a bunch. As a result, it is possible to suppress the efflux of the allochroic agent during the production process and the efflux of the allochroic agent associated with water leakage during actual use.

The mixing ratio of mannan, the electrolyte, the thickener, the allochroic agent, and water is, for example, 8:2:3:1:340. Specifically, the electrolyte and water are mixed to prepare an aqueous electrolytic solution, and to this solution, mannan, the thickener and the allochroic agent are gradually added while stirring. The mixing ratio of the total weight of mannan, the electrolyte, the thickener and water to the weight of the allochroic agent is, for example, 99:1. The content ratio of the electrolyte (sodium chloride) relative to the total amount of the stock liquid thus prepared is preferably 1.0% by weight or less, and more preferably 0.7% by weight or less and 0.01% by weight or more. The content ratio by weight of the thickener relative to the total amount of the stock liquid is preferably 5.0% by weight or less, and more preferably 3.0% by weight or less and 0.5% by weight or more. The content ratio by weight of the allochroic agent relative to the total amount of the stock liquid is preferably 0.5% by weight or more, and more preferably 1.0% by weight or more. The stock liquid thus prepared is allowed to stand for a while.

Then, an alkaline substance such as calcium hydroxide or calcium carbonate is added to the stock liquid, and the mixture is gelatinized by further stirring. In this way, a so-called konjac paste can be obtained.

<Shaping Step (S120)>

In a shaping step S120, the konjac paste is shaped into the same shape as an animal organ of interest. If the animal organ is, for example, a viscera, the konjac paste is poured into a mold in the shape of the viscera to three-dimensionally shape the paste. If the animal organ is a skin, the konjac paste is poured into a plate-shaped mold to shape the paste into a sheet. If the animal organ is a blood vessel, the konjac paste may be continuously extruded through a circular hole or a ring-shaped hole to shape the paste into a string or tube. It goes without saying that the paste may be shaped not by extrusion but by using a mold into a blood vessel, an intestinal tract, an esophagus, a lung, a tongue or the like. As a result, a shaped body made of the konjac paste shaped into a desired shape can be obtained.

<Freezing Step (S130)>

In a freezing step S130, the shaped body is kept for a certain period of time in a low temperature environment where the temperature is lower than 0° C. This causes the shaped body to change into a fiber structure or a mesh structure, and therefore, the allochroic agent is supported by the fiber structure or the mesh structure. Thus, even after thawing, the allochroic agent is tightly retained inside and around the fiber structure or the mesh structure, and therefore, the efflux of the allochroic agent into the water (drip) is reduced. In this connection, the fiber structure or the mesh structure leads to an increase in the tensile strength and the tear strength of the shaped body. For example, for practicing a surgical technique for an organ, in some cases, the organ is incised with an electric knife, and forceps are inserted through the incision and used to pinch the inside tissue of the organ. The reason for this is that it is necessary to incise a deeper part while the inside tissue of the organ is pinched with the forceps or to perform peeling or excision surgery while the inside tissue of the organ is pulled with the forceps. Thus, the freezing step is performed to increase the tensile strength and tear strength of the inside of the shaped body, thereby providing an environment for practicing such a surgical technique.

In the freezing step S130, at least a part of the shaped body is frozen. Freezing the shaped body leads to development of the fiber structure or the mesh structure, in which the components in the konjac paste bind to each other more strongly. Consequently, cases where the shaped body is squashed or torn off when pinched with forceps can be appropriately reduced, and thus, an inside state extremely similar to that of an actual organ can be achieved. For efficient freezing, the shaped body is kept, for example, in an environment of preferably −10° C. or lower, and more preferably −20° C. or lower. For example, the shaped body can be kept at about −27° C. for 30 minutes to several hours. When the thickener is contained, the shaped body is kept preferably, for example, at −5° C. or lower and −15° C. or higher. Since appropriate fibrillization proceeds, suitable strength can be ensured while the amount of leaking water is kept low at the time of incision with an electric knife. The shaped body is kept, for example, at about −8° C. for 10 hours. In relation to this, when the shaped body is frozen at a temperature lower than −15° C. (for example, at −20° C.), excessive fibrillization may occur, leading to a reduced water-holding capacity, which may in turn reversely increase the amount of leaking water at the time of incision with an electric knife.

Besides, in this freezing step S130, it is preferred that a center portion of the shaped body is kept in an unfrozen state with an outer surface portion thereof frozen. Thus, a simulated animal organ in which the tensile strength is stronger on a surface side and gradually becomes weaker toward a center portion can be obtained. Furthermore, owing to a difference in characteristic value between the frozen portion and the unfrozen portion, a boundary can be formed and a peeling technique can be trained along the boundary. An actual organ also includes a large number of such structures, and hence, such a simulated animal organ is an extremely preferable aspect for the training.

After thawing, drips may generate from the shaped body. It is preferable to intentionally allow drips to generate from the shaped body after thawing and adjust the final moisture content thereof to 80% to 95%.

<Drying Step (S140)>

In a drying step S140, a water component of the shaped body is evaporated for drying. In this drying step S140, merely a portion in the vicinity of the outer surface of the shaped body may be dried, and thus, the tensile strength of the outer surface alone can be increased. In some kinds of organs, it is sometimes more practical that there is an epidermis (or an outer bag), and an epidermis can be simulatively formed through this drying step S140. Incidentally, if there is no need to form an epidermis, this drying step S140 can be omitted.

On the other hand, if the shaped body is dried too much in the drying step S140, the resultant shaped body becomes a so-called jerked state, and it is apprehended that the tensile strength becomes so high that reproducibility for an actual living body may become poor. Besides, it is difficult to completely dry also the inside of the shaped body. If the shaped body is to be dried deep inside, the surface thereof is dried too much. Accordingly, for reproduction of an organ, the freezing step S130 for causing appropriate strength is preceded, and it is preferable to combine the drying step S140 with that step to suitably control the tensile strength of the inside and the tensile strength of the outer surface of the shaped body. At this point, the drying step S140 is preferably performed after the freezing step S130, but the drying step S140 may be performed before the freezing step S130 in some cases in accordance with the purpose of an organ to be reproduced.

Incidentally, it is possible to simultaneously perform the freezing step S130 and the drying step S140 by so-called vacuum-freeze drying.

For example, if the freezing step S130 is performed before the drying step S140, both the outer surface and the inside are changed into a rather mesh-like form (a fibrous form), and hence the tensile strength can be increased as a whole. Although the hardness of the outer surface is increased through the following drying step S140, the mesh-like form constitution is not particularly changed.

On the other hand, if the drying step S140 is performed before the freezing step S130, the outer surface becomes smooth (is placed in a dense state), and hence, the strength of the outer surface can be locally increased. Merely the inside becomes a rather mesh-like form through the following freezing step S130, and the tensile strength of the inside can thus be increased. Accordingly, an organ produced by, for example, performing the drying step S140 before the freezing step S130 is advantageous in that even if training to inject a liquid through an outer surface into inside thereof with a needle is performed, the liquid is difficult to leak through the outer surface.

<Packaging Step (S145)>

In a packaging step S145, the shaped body is immersed in a strong alkaline liquid and placed in a desired container or bag in such a state. For example, it is preferable to use a vacuum packaging machine to evacuate air from the inside of a resin bag, place the shaped body therein in this state, and heat-seal the bag. Preferably, a material for a packaging bag is, for example, a composite film material whose outer surface is made of nylon and inner surface is made of polyethylene. Such a material can provide heat resistance, heat sealability, and oxygen impermeability at the same time. It is also desirable to use retortable packaging. The packaging step (S145) can also be performed in a preserving step (S160) described below.

<Heating Step (S150)>

In a heating step S150, the packaged shaped body is heated to a temperature higher than the first temperature of the allochroic agent. The shaped body is more preferably heated to a temperature higher than the first fixation temperature. This heating step S150 temporarily changes the color of the allochroic agent to the first hue. This heating step S150 can also enhance the elasticity of the shaped body. In this way, the heating step S150 is performed to start the color change of the allochroic agent or to fix the changed color on a temporary basis. This enables a visual examination of whether or not the allochroic agents are homogeneously dispersed. Specifically, the shaped body is heated to preferably 50° C. or higher, and more preferably 60° C. or higher. For example, the shaped body may be immersed in boiled water at a temperature not lower than the first fixation temperature and heated for several tens of minutes. In relation to this, some kinds of organs do not need to be elastic. In such a case, the heating time may be shortened, the heating temperature may be lowered to a temperature not lower than normal temperature, or heating step S150 may be omitted. However, this heating step S150 can also serve as a sterilizing step, and therefore, it is preferable to perform heating at a temperature not lower than a sterilization temperature (e.g., 75° C.) as needed. It goes without saying that sterilization can also be performed by a method other than the heat sterilization.

This heating step S150 is preferably performed after the freezing step S130 and the drying step S140. If the elasticity is provided by performing the heating step S150 in advance, it is difficult to attain desired tensile strength even if the freezing step S130 or the drying step S140 is performed thereafter. Through the above-described steps, a simulated animal organ 10 is completed.

<Re-Cooling Step (S155)>

In a cooling step S155, the shaped body heated in the heating step S150 is kept for a certain period of time in a low temperature environment where the temperature is lower than the second temperature for the allochroic agent.

This process restores the color of the allochroic agent that has turned into the first hue in the heating step S150 to the second hue. The shaped body is cooled preferably to 5° C. or lower, and more preferably to 0° C. or lower. It is also preferable that the shaped body be refrozen in this cooling step S155, particularly preferably by cooling it to −5° C. or lower. In this embodiment, for example, the shaped body is kept at −10° C. or lower for 1 hour or more.

<Preserving Step (S160)>

In a preserving step S160, the simulated animal organ 10 completed through a plurality of steps described above is preserved. The packaging step (S145) may be carried out at this time. In this manner, the simulated animal organ can be stored at normal temperature or refrigerated for several months to several years.

It is preferable that the moisture content be set to 95% or less in the simulated animal organ 10 immediately before the preserving step (S160) or the packaging step (S145). This can keep the amount of leaking water low at the time of incision with an electric knife. At the same time, it is preferable that the moisture content of the simulated animal organ 10 be set to 80% or more. When the moisture content falls to 80% or less, the difference to a human organ felt at the time of technique training becomes greater and a sense of incongruity is more likely to occur. Desirably, the moisture content is set to 94% or less. The moisture content can be calculated by the following formula: moisture content=(final weight of end product−weight of raw material)/(final weight of end product).

Furthermore, it is preferable that the compressive (tensile) elastic modulus of the simulated animal organ 10 be set to 0.015 N/mm2 or less in immediately before the preserving step (S160) or the packaging step (S145). More preferably, the compressive (tensile) elastic modulus is set to 0.011 N/mm2 or less. By setting the elastic modulus to a low value as described above, a user can obtain an appropriate stretching feeling when pinching the simulated animal organ 10 with forceps. Note that it is preferable to set the compressive (tensile) elastic modulus to 0.001 N/mm2 or more.

As described above, in the production process, the simulated animal organ 10 is kept in a highly flexible and stretchable state by setting the elastic modulus to a low value, while the moisture content thereof is adjusted to a lower value. Furthermore, since the allochroic agent is supported along the fiber inside of the simulated animal organ 10, the allochroic agent moves in concert with the expansion and contraction of the simulated animal organ 10.

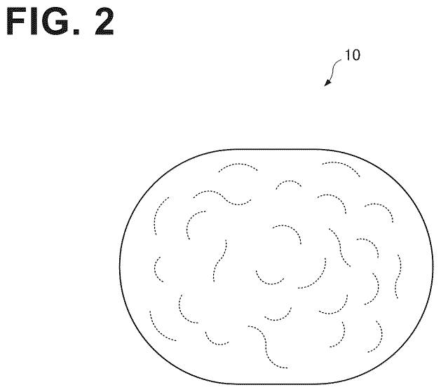

FIG. 2 illustrates the simulated animal organ 10 produced through the above-described steps. This simulated animal organ 10 is highly reproducible for an actual organ such as a viscera. Specifically, it has the following advantages:

(1) Control of Temperature Change

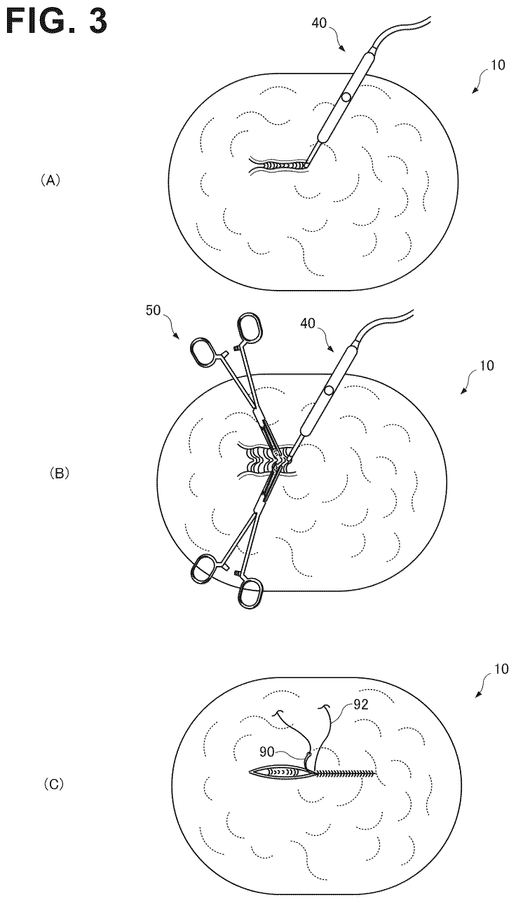

The present simulated animal organ 10 includes an allochroic agent whose color is temporarily fixed to the second hue in an unused state. Thus, for example, as shown in FIG. 3(A), in practicing a surgical technique using an electric knife 40, the extent of the thermal damage to the simulated animal organ 10 caused by the electric knife can be visually identified by the extent of color change to the first hue (e.g., white). In addition, in practicing a surgical technique such as catheter ablation, the extent of thermal cauterization of the simulated animal organ 10 can also be visually identified by the extent of color change to the first hue. Furthermore, it can be visually identified by the extent of color change of the allochroic agent whether or not the heat generated by the electric knife or the catheter propagates through the simulated animal organ 10 or the air and affects an area other than the incision site.

(2) Conductivity

The present simulated animal organ 10 has conductivity. This property makes it possible for a user to practice a surgical technique using an electric knife 40 as shown in FIG. 3(A). Furthermore, when the user incises the simulated animal organ 10 with the electric knife, the user can obtain a feeling extremely close to that obtained from an actual organ. In particular, since the present simulated animal organ contains the electrolyte, the conductivity can be further enhanced. Accordingly, for example, in a surgical technique where a monopolar electric knife is used with a counter electrode plate, the response of the simulated animal organ to incision can be stabilized. In particular, the content ratio of the electrolyte (sodium chloride) in the stock liquid is set to preferably 1.0% by weight or less, and more preferably 0.7% by weight or less and 0.01% by weight or more, which enables the simulated animal organ to respond to incision in a similar manner to an actual animal organ. In relation to this, when the content ratio of the electrolyte is too high, an electric knife device may sound a trouble alert (alarm).

(3) Storage Property

The present simulated animal organ 10 can be stored for a long period of time. If the package is not opened, the simulated animal organ 10 can be stored at normal temperature for 1 or more years, and even if the package is opened, it can be stored for several days.

(4) Disposability

The present simulated animal organ 10 contains a natural plant-derived component (food) as a main component, it can be simply discarded similarly to garbage. Besides, an environment-polluting substance is not generated in disposal (for example, incineration or landfill) performed after the discard.

(5) Inexpensiveness and Hygienic Property

The present simulated animal organ 10 can be mass-produced extremely inexpensively. As a result, simulated animal organs can be frequently exchanged (discarded), resulting in enabling surgical technique training to be performed always under a hygienic environment.

(6) Usage of Forceps

The present simulated animal organ 10 has appropriate tensile strength also inside thereof. Accordingly, as illustrated in FIG. 3(B), it is possible to perform training of a surgical technique to pinch, hold and pull inside tissue of an incised organ with forceps 50. Incidentally, if the freezing step S130 is omitted in the production, the inside tissue is so soft that the material can be torn off when pinched with the forceps 50.

(7) Suturing Characteristic

As illustrated in FIG. 3(C), in the present simulated animal organ 10, an incised portion can be sutured using a surgical needle 90 and surgical thread 92. For performing suture training, it is preferable that the tensile strength of the surface be increased through the freezing step S130 or the drying step S140.

(8) Ultrasonography

In the present simulated animal organ 10, an output state close to that of an actual organ can be attained also in echography (ultrasonography). Accordingly, the simulated animal organ 10 can be used for training of echography, and besides, a series of training of a combination of echography and surgical operation can be performed using a single simulated animal organ 10. The simulated animal organ 10 is similarly applicable to various diagnostic imaging apparatuses (including X-ray, CT, MRI and the like).

(9) Drip Inhibition

Since the present simulated animal organ 10 contains the thickener, it can hold moisture. Therefore, when the simulated animal organ is incised with an electric knife, the amount of leaking water generated at the same time as incision can be kept low (appropriately controlled). This also leads to a response from the simulated animal organ to incision in a similar manner to that of an actual animal organ. Furthermore, since the allochroic agent is supported by the fiber structure or mesh structure of the mannan, the content of the allochroic agent in the moisture held by the thickener can be kept low. This prevents the allochroic agent from flowing out together with the leaking water generated at the same time as incision with the electric knife, thereby enabling a precise evaluation of the effect of heat on not the water component, but the fiber structure or mesh structure of the mannan. When the amount of the thickener is too small (or the thickener is not contained), the amount of leaking water at the time of incision is excessively increased, and the generated water component may cause the electric knife device to sound a trouble alert (alarm). For the present simulated animal organ 10, the freezing step S130 is performed after the thicker was mixed in, and thus, both an appropriate strength and drip inhibition can be attained.

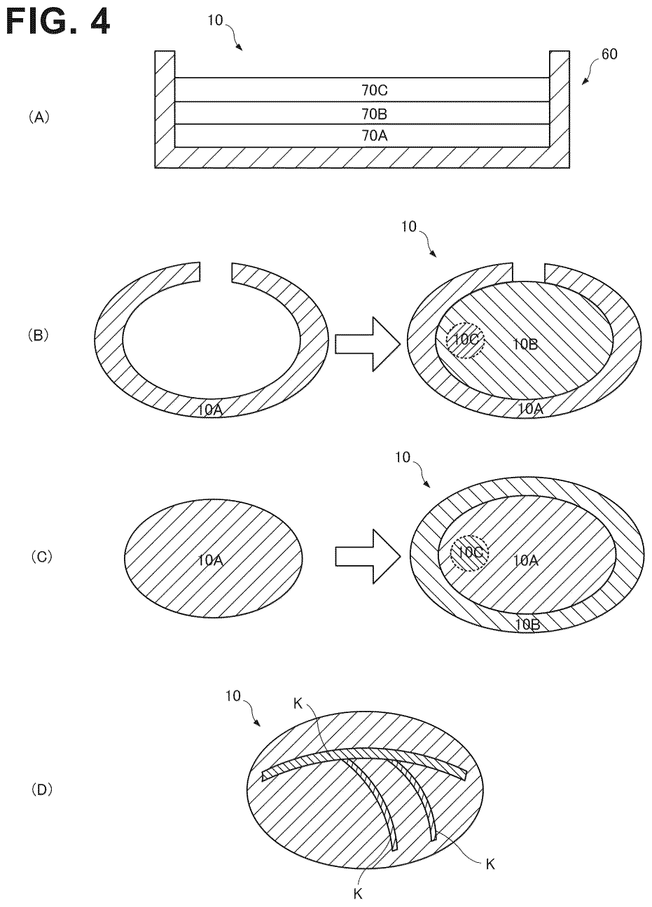

In the above-described first embodiment, a case where the production is performed by using a single stock liquid or through single shaping step S120 is described as an example, but the present invention is not limited thereto. For example, a plurality of stock liquids may be prepared to be separately poured into a mold to form a multilayer structure. As illustrated in FIG. 4(A), when a plurality of stock liquids 70A, 70B and 70C are stacked in a mold 60 in a plate shape, and different characteristics are provided through the freezing step S130, the drying step S140 and the heating step S150 performed thereafter, a multilayer simulated animal organ 10 can be obtained. Alternatively, it is also preferable to appropriately selectively perform the freezing step S130, the drying step S140 and the heating step S150 after stacking the first stock liquid 70A, to appropriately selectively perform the freezing step S130, the drying step S140 and the heating step S150 after stacking the second stock liquid 70B, and to appropriately selectively perform the freezing step S130, the drying step S140 and the heating step S150 after stacking the third stock liquid 70C. When the production is performed through a plurality of steps in this manner, even if the first through third stock liquids 70A, 70B and 70C have the same composition, different characteristics can be provided to respective layers because there is a time difference in the freezing step S130, the drying step S140 and the heating step S150 performed thereafter.

Alternatively, as illustrated in FIG. 4(B), after forming a first simulated animal organ 10A in a bag shape using a mold, a second simulated animal organ 10B may be formed inside by pouring a raw material into the first simulated animal organ, so as to produce an integrated simulated animal organ 10 as a whole. On the contrary, as illustrated in FIG. 4(C), after forming a first simulated animal organ 10A in a bulk shape using a mold, a second simulated animal organ 10B may be formed by pouring a raw material around the first simulated animal organ using a mold not illustrated, so as to produce an integrated simulated animal organ 10. In this case, the simulated animal organ 10 may be produced with a foreign matter 10C formed to simulate a tumor or the like embedded inside, for example, as illustrated with a dotted line. In this manner, a surgical technique to take out the tumor or the like can be trained, or echography for detecting a foreign matter can be trained.

As illustrated in FIG. 4(D), by employing the production method of the first embodiment or another production method, a simulated blood vessel K in a string or tubular shape simulating a blood vessel (that can be a foreign matter) can be formed, and the simulated blood vessel K may be embedded in the simulated animal organ 10. In this manner, a surgical technique to incise the simulated animal organ 10 with an electric knife or the like to take out the blood vessel K from inside or to anastomose (connect) the blood vessel K thereinside can be trained.

### EXAMPLE

A simulated animal organ 1 was produced according to a production method according to the first embodiment of the present invention. Specifically, in the kneading/gelatinizing step (S110), mannan, an electrolyte, a thickener, an allochroic agent, and water were mixed and kneaded to obtain a stock liquid. The allochroic agent used for this purpose was an allochroic agent whose particle diameter (median diameter) is 0.9 to 1.3 μm and whose first hue is white and second hue is brown. A material satisfying the following temperature conditions for the allochroic agent was used: the first temperature thereof is 60° C., the first fixation temperature thereof is 95° C., the second temperature thereof is 0° C., and the second preparation completion temperature thereof is −18° C. Specifically, Memory Type thermochromic material available from NCC was used. Note that the allochroic agent before kneading was in the second hue state. Then, calcium carbonate was added to the stock liquid, and the mixture was gelatinized by further stirring. In the shaping step (S120), the gelatinized stock liquid was shaped into a sheet. Next, in the freezing step (S130), the shaped body was stored in a frozen state. After confirming that the moisture content after completion of freezing was 80% to 95%, the shaped body was packaged in the packaging step (S145), and then stored at room temperature for 10 hours in the heating step (S150). Next, in the re-cooling step (S155), the shaped body was kept at −18° C. for 24 hours to fix the color of the allochroic agent to the second hue (brown). Then, the temperature of the shaped body was allowed to rise up to room temperature, thereby completing the simulated animal organ 1.

(Examination 1)

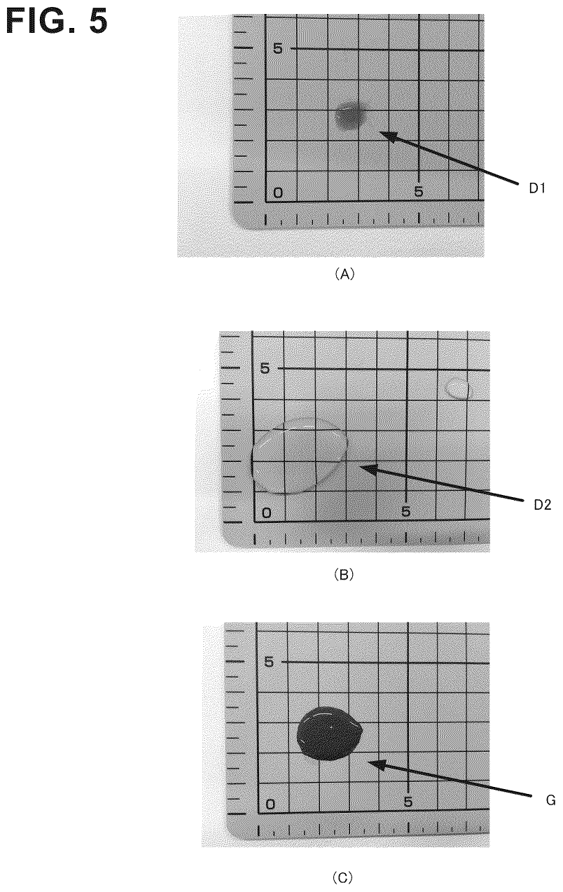

For examining the simulated animal organ obtained, after the shaping step (S120) and before the freezing step (S130), the shaped body was compressed to squeeze out drips, and the color thereof was observed. As a result, a red drip D1 flowed out as shown in FIG. 5(A). Next, this shaped body was subjected to the freezing step (S130), and then the shaped body was compressed to squeeze out drips and the color thereof was observed. As a result, a transparent or pale yellow drip D2 flowed out as shown in FIG. 5(B). Thus, it was confirmed that even after the shaping step (S120), the shaped body had a week ability to retain the allochroic agent before the freezing step (S130), and thus, part of the allochroic agent was prone to flow out together with water when the shaped body was compressed by applying an external force. In contrast, it was confirmed that, after the freezing step (S130) was performed, most of the allochroic agent was supported by the shaped body, and even when the shaped body was compressed by applying an external force, the efflux of the allochroic agent was significantly reduced. In other words, it was revealed that the retaining ability or retention rate (retention amount) of the shaped body for the allochroic body was increased by the freezing step (S130). FIG. 5(C) shows a photograph obtained by directly photographing only an allochroic agent G before kneading.

(Examination 2)

Next, the completed simulated animal organ 1 was observed for examining the state of the tissue thereof. Specifically, the simulated animal organ 1 was frozen in liquid nitrogen and then dried by freeze-drying to prepare a sample for observation, and the sample was examined with a desktop microscope. FDU-1200 manufactured by EYELA was used as the freeze dryer, and the simulated animal organ 1 was treated for 20 hours under the drying conditions set to a temperature of −45° C. and a pressure of 20 Pa. TM-1000 manufactured by Hitachi High-Tech Corporation was used as the desktop microscope and the observation conditions were set to an acceleration voltage of 15000 V, an emission current of 53.3 mA, a degree of vacuum of 15.0 kV, and a working distance of 5.56 mm.

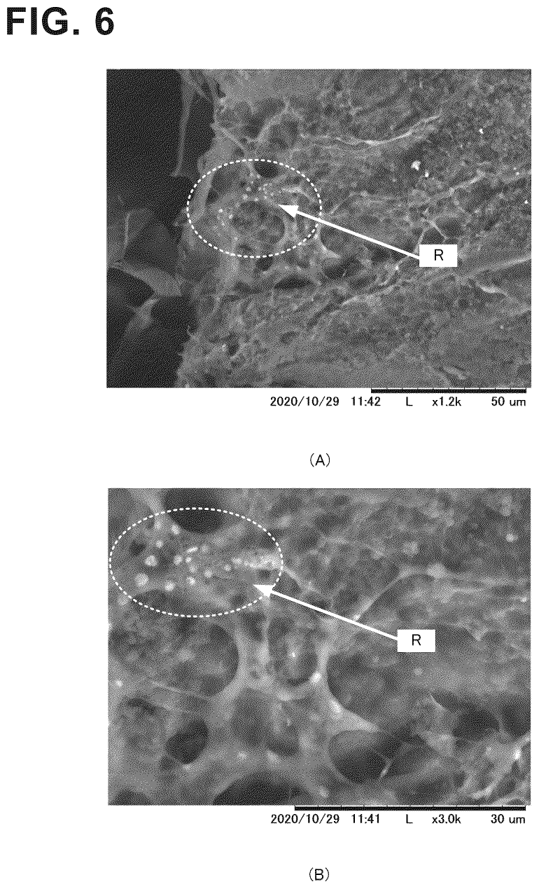

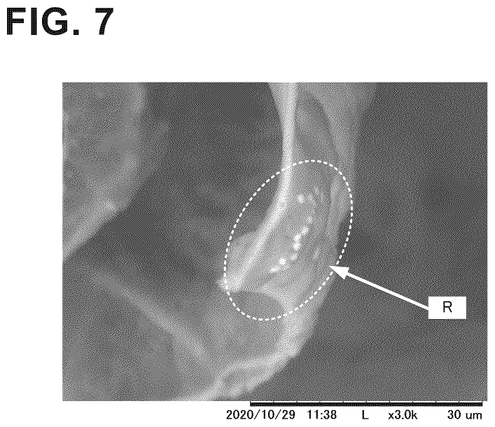

From the observation results shown in FIGS. 6(A) and 6(B), it was confirmed that an allochroic agent R in the form of a microcapsule was retained in the fiber structure or the mesh structure generated through the freezing step (S130). In particular, as can be seen from FIG. 6(B), it was confirmed that the allochroic agent R having a particle diameter of 2.0 μm or less was supported within the fiber structure or the mesh structure. As is seen from the observation results shown in FIG. 7, it was confirmed that 50% or more of the allochroic agent R in the form of a microcapsule (individual) was incorporated (embedded) in the fiber structure or the mesh structure, with part of the allochroic agent R exposed above the surface of the fiber structure or the mesh structure. These results indicate that, when the allochroic agent R is supported, the allochroic agent R can be retained more strongly and the color change status thereof can be visually recognized from the outside easily.

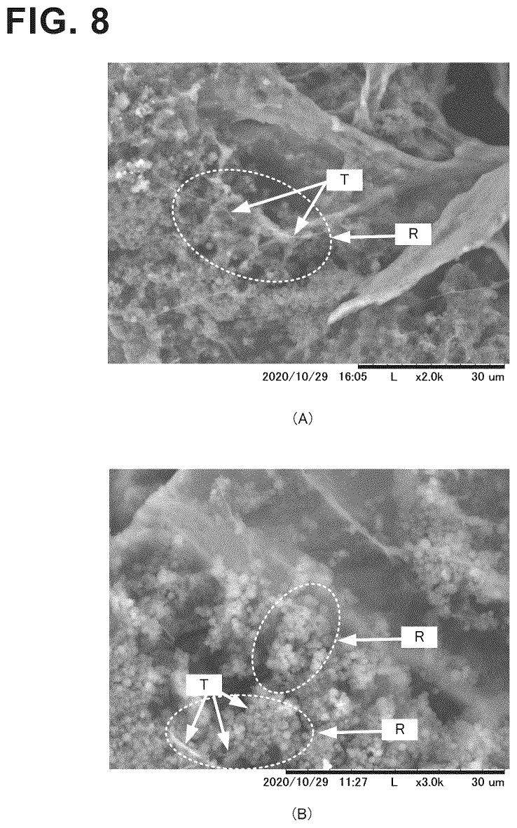

Furthermore, as is shown in the observation results in FIGS. 8(A) and 8(B), it was confirmed that the allochroic agent R in the form of a microcapsule was retained along the fiber of the fiber structure or the mesh structure generated through the freezing step (S130), with the allochroic agent forming a bunch (cluster). In particular, as can be seen from FIG. 8(B), it was confirmed that the allochroic agent R having a particle diameter of 2.0 μm or less was supported, in an aggregated state, within the fiber structure or the mesh structure. It was confirmed that these bunches of the allochroic agent R were supported by the fiber structure or mesh structure T having a fiber diameter or membrane thickness of 0.3 μm or less.

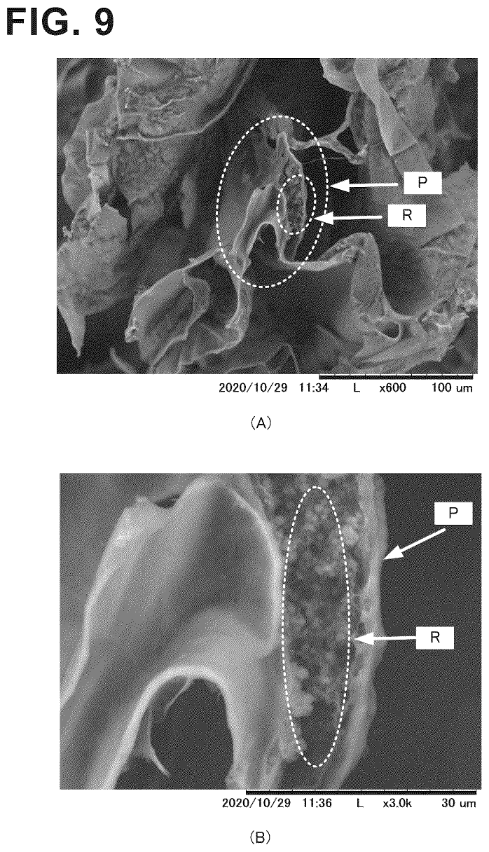

Furthermore, as shown in FIGS. 9(A) and 9(B), it was confirmed that a pocket-like recess P had been formed in the fiber structure or the mesh structure generated through the freezing step (S130), and the allochroic agent R in the form of a microcapsule was housed in the recess P, forming a bunch (cluster). Thus, it was confirmed that the fiber structure or the mesh structure served as a container for housing the allochroic agent R.

As described above, the simulated animal organ 1 of the present embodiment has the fiber structure or mesh structure of the mannan as a main component that securely supports the allochroic agent R, which inhibits the efflux of the allochroic agent R even when an external force or vibration is applied during long-term storage or transportation. In particular, the fiber structure or the mesh structure enables the allochroic agent R to be supported in a bunch form or a large quantity of the allochroic agent R to be retained in the recess P, thereby enhancing visibility thereof at the time of color change.

(Examination 3)

Next, the elastic modulus of the completed simulated animal organ 1 was measured. Specifically, the measurement was performed by using a compact desktop compression/tension tester (EZ-SX) manufactured by Shimadzu Corporation. Columnar test pieces 10 mm in diameter and 10 mm in length were made from the simulated animal organ 1. The stress of the test piece when compressed at a rate of 10 ram/min was measured by using a load cell and the elastic modulus of the test piece at 10% deformation was calculated. Three test pieces were prepared and the measurement results thereof were 0.01303 N/mm2, 0.00849 N/mm2, and 0.1076 N/mm2. In relation to this, common edible konjac was measured by the same method and the obtained measurement result was 0.0160 N/mm2.

Next, an application of a method of using the present simulated animal organ 10 will be described.

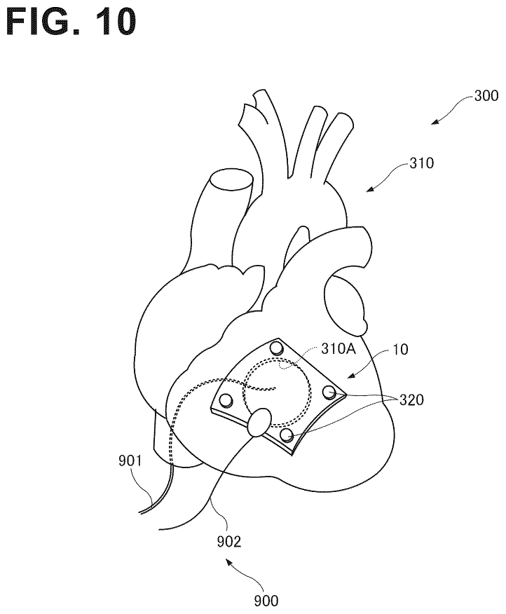

As shown in FIG. 10, a simulated animal organ kit 300 according to a second embodiment of the present invention includes the simulated animal organ 10 of the first embodiment and a three dimensional organ model 310 formed of a resin or metal. In this case, the simulated animal organ 10 is shaped into a sheet. In this case, the organ model 310 is an organ model 310 of a heart made of a plastic, silicone, or rubber. An opening 310A is formed on a part of the wall surface of this organ model 310, and the simulated animal organ 10 is fixed to the organ model 310 so as to cover the opening 310A. Thus, the part of the wall surface of the organ model 310 is replaced with the simulated animal organ 10. The present embodiment illustrates a case where the simulated animal organ 10 is fixed to the organ model 310 with a fixing pin or fixing screw 320. However, the simulated animal organ 10 may be disposed over the opening 310A with a clip or other holding structures.

For example, when the simulated animal organ kit 300 is used to practice a technique of catheter ablation for atrial fibrillation using an ablation device 900 as a medical device, a counter electrode plate 902 is disposed in contact with the outside of the simulated animal organ 10, and an electrode catheter 901 is inserted into the organ model 310 via a vein or an artery. The tip electrode of the electrode catheter 901 is brought into contact with the inside of the simulated animal organ 10 through the opening 310A of the organ model 310, and then a high-frequency current is passed through the catheter to electrically burn the contact area. This causes the allochroic agent in the simulated animal organ 10 to change its color to the first hue, which allows for visually identifying the cauterized area.

While the organ model 310 of a heart has been described here by way of illustration, the present invention is not limited to this. Three dimensional models of organs may be those of any other organ such as a stomach, an esophagus, a lung, a liver, a kidney, a large intestine, or a small intestine. Furthermore, while the sheet-like simulated animal organ 10 has been described here by way of illustration, the simulated animal organ 10 may have a tubular shape or any other shape.

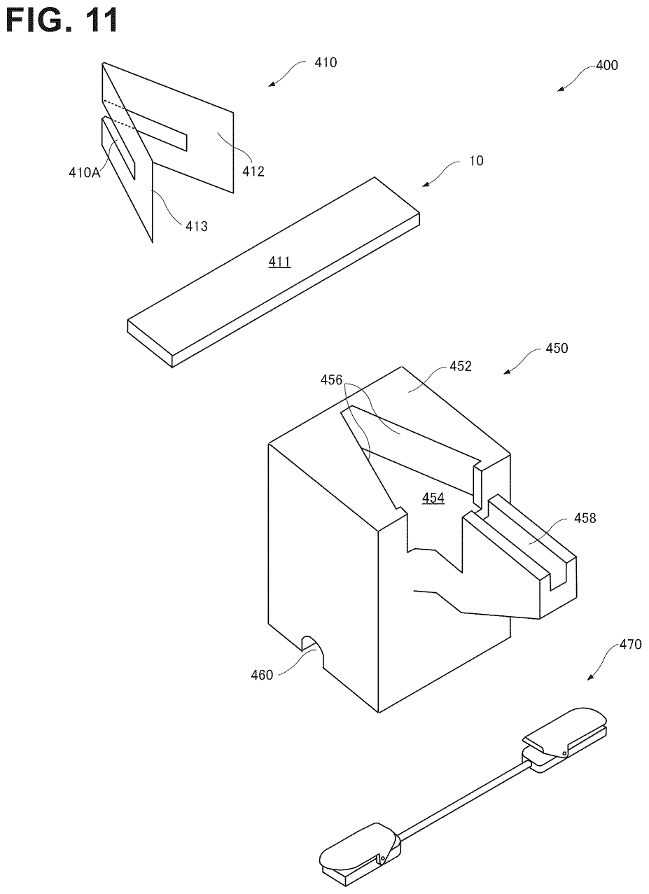

As shown in FIG. 11, a medical instrument evaluation kit 400 according to a third embodiment of the present invention includes the simulated animal organ 10 of the first embodiment, an allochroic sheet 410 composed of paper or a resin film, a base 450, and a fixing jig 470. The simulated animal organ 10 is shaped into a strip.

The allochroic sheet 410 is folded into a V-shape to form a pair of opposing faces (a second surface 412 and a third surface 413). These opposing faces (the second surface 412 and the third surface 413) change their color by heat. In this allochroic sheet 410, a slit 410A extending from the top edge of the V-shape toward both bottom edges is made, and the simulated animal organ 10 is inserted into the slit 410A. The color change sensitivity of the opposing faces (the second surface 412 and the third surface 413) is preferably set to a level higher than that of the simulated animal organ 10. Specifically, it is preferable that the opposing faces begin to change their color at a temperature lower than the first temperature (a temperature at which the color change begins during the temperature rise) of the simulated animal organ 10 and the changed color be fixed at a temperature lower than the first fixing temperature of the simulated animal organ 10.

The base 450 is a pedestal having a rectangular parallelepiped shape, and the simulated animal organ 10 is disposed on a placement surface 452, an upper surface of the base. Since the strip of the simulated animal organ 10 is longer than the length of the placement surface 452, each end of the simulated animal organ 10 protrudes from the placement surface 452 and bends toward the lower part of the side faces of the base 450. A recess 454 is formed on the placement surface 452, and a part of the recess 454 is opened to a side face of the base 450. By using this recess 454, a medical device can be inserted on the underside of the simulated animal organ 10. In the base 450, a holder 458 for holding the medical device is provided protruding from the side face to which a part of the recess 454 is open. The recess 455 has a V-shape in a plan view, and a pair of opposing inner walls 456 thereof holds the V-shaped allochroic sheet 410. A groove 460 is formed on the underside of the base 450 and the groove 460 holds the fixing jig 470.

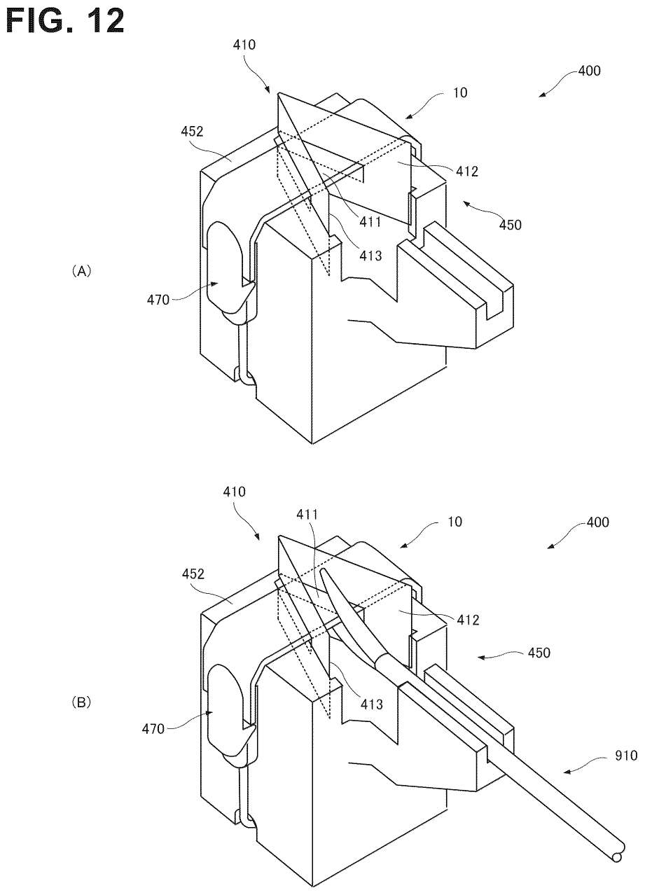

For example, the fixing jig 470 has a structure in which a pair of clips are disposed at both ends of a rubbery stretchable material. The stretchable material is placed along the groove 460 of the base 450 and both ends of the simulated animal organ 10 mounted on the placement surface 452 are held by the clips at both ends of the stretchable material. As a result, as shown in FIG. 12(A), the simulated animal organ 10 is fixed to the placement surface 452 in such a manner as to wind around the base 450. The V-shaped allochroic sheet 410 is pushed into the recess 454 from the side face of the recess 454 in the base 450. As a result, the allochroic sheet 410 is fixed to the recess 454, with the simulated animal organ 10 being inserted into the slit 410A.

The medical instrument evaluation kit 400 assembled by the above-described procedure includes a first surface 411 composed of the simulated animal organ 10; a second surface 412 provided in a direction orthogonal to the first surface 411, the second surface 412 having a thermochromic property; and a third surface 413 provided in a direction orthogonal to the first surface 411 and spaced from the second surface 412, the third surface 413 having a thermochromic property. A space surrounded by the first surface 411, the second surface 412, and the third surface 413 constitutes a thermal evaluation space. The thermal evaluation space is a triangular prism-shaped space that extends in both upward and downward directions orthogonal to the first surface 411, which is a boundary.

FIG. 12(B) illustrates an aspect in which the medical instrument evaluation kit 400 is used to perform a thermal evaluation of a bipolar electric knife 910 used as a medical device. In this aspect, the electric knife 910 is held by the holder 458, and the first surface 411 of the simulated animal organ 10 is cut by sandwiching the first surface 411 with tweezer-shaped electrodes at the tip of the electric knife 910. During this cutting process, a temperature rise occurs in the thermal evaluation space due to the temperature rise of the tweezer-shaped electrodes, the temperature rise of the simulated animal organ 10, water vapor generated from the simulated animal organ 10, and the like. The heat in the thermal evaluation space is also transferred to the second surface 412 and the third surface 413, causing color change thereof. As a result, the effect of heat on not only the first surface 411 but also the second surface 412 and the third surface 413 surrounding the first surface 411 can be visually observed. In general, when the electric knife 910 is used, the effect of heat on the cut part (in this case, the first surface 411) during surgery is allowed as a matter of course, but it is not preferable that the effect of heat be exerted on the surrounding area unrelated to the cut part. By using the medical instrument evaluation kit 410, an electric knife 910 having a low heat effect on the second surface 412 and the third surface 413 can be determined to have a high performance in terms of heat effect, whereas an electric knife 910 having a high heat effect on the second surface 412 and the third surface 413 can be determined to have a low performance in terms of heat effect.

With respect to the medical instrument evaluation kit 400, a case where the thermal evaluation space is formed as a triangular prism-shaped space was described above by way of illustration, however, the present invention is not limited thereto. A space in the shape of a polygonal prism such as a quadrangular prism or a hexagonal prism, a cylindrical space (including a partial cylindrical space having a partial arc), a spherical space, or a space in any other shape such as a cone or a polygonal pyramid may be used. Although a case where the thermal evaluation space has an open top has been illustrated, the top may be closed.

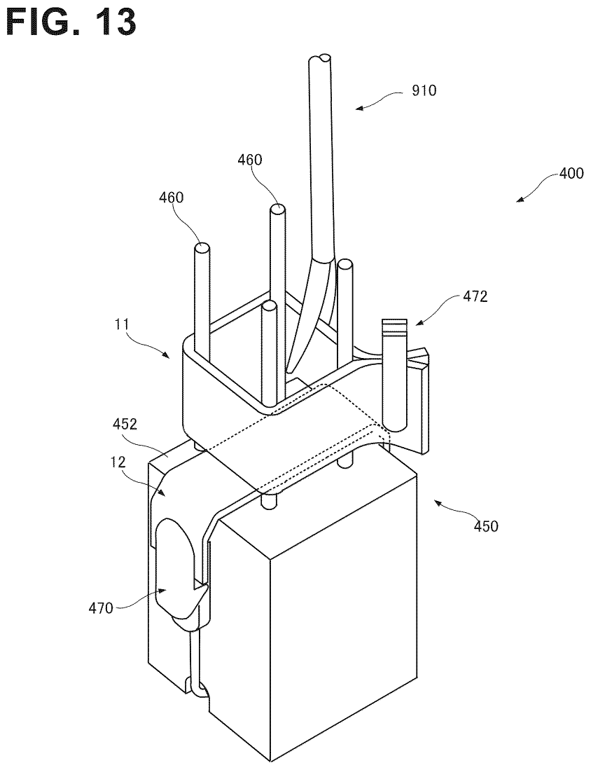

FIG. 13 shows a medical instrument evaluation kit 400 according to a modification of the third embodiment. In this medical instrument evaluation kit 400, four holding rods 460 serving as holding fixtures are arranged in an upright position on the placement surface 452 of the base 450. A strip-shaped first simulated animal organ 11, which is the first embodiment, is wound around the holding rods 460, and is held by a clip 472 at both ends thereof. As a result, an encircled wall surface is formed by the first simulated animal organ 11, and is a rectangular shape in a plan view.

On the other hand, as described above, a strip-shaped second simulated animal organ 12 is fixed to the placement surface 452 of the base 450 by the fixing jig 470. The second simulated animal organ 12 constitutes the bottom of the area surrounded by the first simulated animal organ 11.

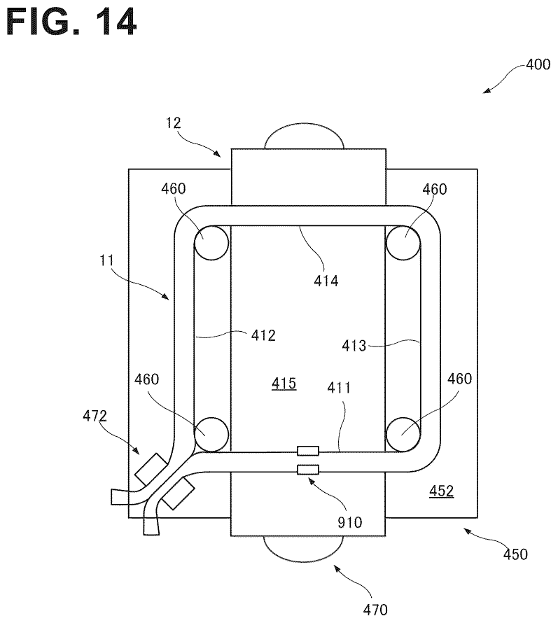

As shown in FIG. 14, when one of the peripheral walls of the first simulated animal organ 11 is defined as the first surface 411, the remaining three peripheral walls of the same first simulated animal organ 11 form the second surface 412 and the third surface 413, which are orthogonal to the first surface 411 and face each other, and a fourth surface 414, which faces the first surface 411. Furthermore, the second simulated animal organ 12 forms a fifth surface 415, which is orthogonal to all surfaces, that is, the first surface 411 to the fourth surface 414. These five surfaces provide a cubic (quadrangular prism-shaped) space for evaluation.

When the medical instrument evaluation kit 400 is used, the first surface 411 of the simulated animal organ 11 is cut by sandwiching the first surface 411 with tweezer-shaped electrodes at the tip of the electric knife 910. During this cutting process, a temperature rise occurs in the thermal evaluation space due to the temperature rise of the tweezer-shaped electrodes, the temperature rise of the first simulated animal organ 11, water vapor generated from the first simulated animal organ 11, and the like. The heat in the thermal evaluation space is transferred to the second surface 412 to the fourth surface 414, as well as the fifth surface 415 of the second simulated animal organ 12, causing color change thereof. As a result, the effect of heat on not only the first surface 411 but also the surrounding area can be visually observed.

Although a simulated animal organ that contains both the electrolyte and the thickener was illustrated in the above-described embodiments, the present invention is not limited thereto. For example, for the purpose of increasing the stability at the time of incision with an electric knife, the electrolyte may be contained alone to increase the conductivity. Likewise, for the purpose of inhibiting water drip at the time of incision with an electric knife, the thickener may be contained alone. In the above-described embodiments, production examples of an animal internal organ were mainly illustrated, but the present invention is not limited thereto. An organ such as skin, an arm, a mouth, a nose, an ear, a leg, or a finger can be produced.

The following case was illustrated in the above-described embodiments: the allochroic agent in the form of a microcapsule begins to change its color and gradually turns into the first hue, when the temperature thereof exceeds the first temperature (a temperature at which the color change begins during the temperature rise), which is higher than an ambient temperature under ordinary conditions (normal temperature); and furthermore, the color is fixed to the first hue when the temperature thereof exceeds the first fixation temperature (a temperature at which the color is fixed during the temperature rise) higher than the first temperature. The opposite case is also possible. Specifically, the allochroic agent begins to change its color and gradually turns into the first hue, when the temperature falls below the first temperature (a temperature at which the color change begins during the temperature drop), which is lower than an ambient temperature under ordinary conditions (normal temperature); and furthermore, the color is fixed to the first hue when the temperature falls below the first fixation temperature (a fixation temperature during the temperature drop) lower than the first temperature. In this case, the allochroic agent begins to change its color and gradually turns into the second hue, when the temperature thereof exceeds the second temperature (a temperature at which the color change begins during the temperature rise), which is higher than an ambient temperature under ordinary conditions (normal temperature). When the temperature of the allochroic agent exceeds the second preparation completion temperature (a temperature at which preparation is completed during the temperature rise), which is higher than the second temperature, the entire allochroic agent turns into the second hue, completing preparation for color development into the first hue at the next temperature drop. By using such a temperature-drop sensitive allochroic agent, for example, practice or simulation of a cryoablation technique for atrial fibrillation can be realized.

It is noted that the present invention is not limited to the above-described embodiments, and it goes without saying that various changes can be made without departing from the scope of the present invention.

Furthermore, with respect to all of the above-described inventions and embodiments, it is possible as a matter of course to obtain a simulated animal organ that can be used for practicing an ordinal medical technique even when the allochroic body is not included.

Specifically, a non-allochroic simulated animal organ can be obtained by a method for producing a simulated animal organ including a shaping step of mixing mannan as a main component and water, performing gelatinization, and shaping the gelatinized mixture to obtain a shaped body; and a freezing step of freezing the shaped body to form a fiber structure or a mesh structure. In this case, as with the above-mentioned Example, the moisture content of the shaped body at the final product stage is preferably 95% or less, and more preferably, it may be 80% or more. Furthermore, after the freezing step, the compressive elastic modulus of the shaped body may be 0.015 N/mm2 or less, and more preferably, the compressive elastic modulus of the shaped body is set to 0.011 N/mm2 or less.

1. A method for producing a simulated animal organ comprising:
a shaping step of mixing mannan as a main component, an allochroic agent in the form of a microcapsule that changes a color thereof in a temperature-dependent manner, and water, performing gelatinization, and shaping a gelatinized mixture to obtain a shaped body; and
a freezing step of freezing the shaped body to form a fiber structure or a mesh structure.

2. The method for producing the simulated animal organ according to claim 1, wherein the allochroic agent is supported by the fiber structure or the mesh structure in the freezing step.

3. The method for producing the simulated animal organ according to claim 1, wherein a particle diameter of the allochroic agent is 5.0 μm or less.

4. The method for producing the simulated animal organ according to claim 3, wherein the particle diameter of the allochroic agent is 2.0 μm or less.

5. The method for producing the simulated animal organ according to claim 1, wherein the allochroic agent has a property of beginning to turn the color thereof into a first hue when a temperature thereof rises and exceeds a first temperature and beginning to turn the color thereof into a second hue when the temperature thereof in a first hue state drops and falls below a second temperature, which is lower than the first temperature.

6. The method for producing the simulated animal organ according to claim 5, further comprising:
a heating step of heating the shaped body to a temperature higher than the first temperature after the freezing step to turn the allochroic agent into the first hue; and
a cooling step of cooling the shaped body to a temperature lower than the second temperature after the heating step to turn the allochroic agent into the second hue.

7. The method for producing the simulated animal organ according to claim 6, wherein:
the shaped body is heated to 75° C. or higher in the heating step;
the shaped body is cooled to lower than −5° C. in the cooling step;
the first temperature for the allochroic agent is set to a temperature higher than 30° C. and lower than 75° C.; and
the second temperature for the allochroic agent is set to a temperature lower than 20° C. and not lower than −5° C.

8. The method for producing the simulated animal organ according to claim 5, wherein the first hue is white or transparent, and the second hue is red, pink, brown, or darkish brown.

9. The method for producing the simulated animal organ according to claim 1, wherein the shaped body in the shaping step contains 1.0% by weight or more of the allochroic agent.

10. The method for producing the simulated animal organ according to claim 1, wherein a moisture content of the shaped body is 95% or less at a final product stage after the freezing step.

11. The method for producing the simulated animal organ according to claim 1, wherein a moisture content of the shaped body is 80% or more at a final product stage after the freezing step.

12. The method for producing the simulated animal organ according to claim 1, wherein a compressive elastic modulus of the shaped body is 0.015 N/mm² or less after the freezing step.

13. The method for producing the simulated animal organ according to claim 12, wherein the compressive elastic modulus of the shaped body is 0.011 N/mm² or less after the freezing step.

14. A method for producing a simulated animal organ comprising:
a shaping step of mixing a raw material containing mannan as a main component, water, and an allochroic agent in the form of a microcapsule that changes a color thereof in a temperature-dependent manner, performing gelatinization, and shaping a gelatinized mixture to obtain a shaped body, wherein the allochroic agent has a property of beginning to turn the color thereof to a first hue when a temperature thereof rises and exceeds a first temperature and beginning to turn the color thereof to a second hue when the temperature thereof in a first hue state drops and falls below a second temperature, which is lower than the first temperature;
a heating step of heating the shaped body to a temperature higher than the first temperature to turn the allochroic agent into the first hue; and
a cooling step of cooling the shaped body to a temperature lower than the second temperature after the heating step to turn the allochroic agent into the second hue.

15. The method for producing the simulated animal organ according to claim 1, wherein an electrolyte is mixed with the water in the shaping step.

16. The method for producing the simulated animal organ according to claim 15, wherein the shaped body in the shaping step contains the electrolyte in an amount of 1.0% by weight or less.

17. A simulated animal organ produced by the method according to claim 1.

18. A simulated animal organ kit comprising:
the simulated animal organ according to claim 17 formed into a sheet; and
a three dimensional organ model formed from a resin or metal;
wherein the simulated animal organ is fixed to a part of a wall surface of the three dimensional organ model.

19. A medical instrument evaluation kit comprising:
a first surface composed of the simulated animal organ according to claim 17;
a second surface provided in a direction orthogonal to the first surface, the second surface having a property of changing a color thereof by heat; and
a third surface provided in the direction orthogonal to the first surface and spaced from the second surface, the third surface having a property of changing a color thereof by heat.

20. The medical instrument evaluation kit according to claim 19, wherein the second surface and the third surface are composed of paper or a resin film.

21. The medical instrument evaluation kit according to claim 19, wherein the second surface and the third surface are composed of the simulated animal organ.

22. A simulated animal organ comprising:
mannan as a main component;
an electrolyte;
water; and
an allochroic agent in a form of a microcapsule, the allochroic agent changing a color thereof in a temperature-dependent manner, wherein
the allochroic agent is supported by a fiber structure or mesh structure of the mannan.

23. The simulated animal organ according to claim 22, wherein the allochroic agent is supported in a bunch form along the fiber structure or the mesh structure of the mannan.

24. The simulated animal organ according to claim 22, wherein:
a recess is formed by the fiber structure or the mesh structure of the mannan; and
the allochroic agent is housed in the recess.

25. The simulated animal organ according to claim 22, wherein a moisture content is 95% or less and 80% or more.

26. The simulated animal organ according to claim 22, wherein a compressive elastic modulus is 0.015 N/mm² or less.
